(19) United States
(12) Patent Application Publication
(10) Pub. No.: US 2008/0001714 A1
(43) Pub. Date: Jan. 3, 2008

(54) Tag information selecting method, electronic apparatus and computer-readable storage medium

(75) Inventors: Shinichi Ono, Kawasaki (JP); Tetsuko Ito, Kawasaki (JP); Yumi Hisanabe, Kawasaki (JP); Aki Nanjo, Kanagawa (JP); Sumito Watanabe, Kanagawa (JP); Yasuharu Kawamura, Kanagawa (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); FUJITSU GENERAL LIMITED, Kawasaki (JP)

(21) Appl. No.: 11/806,661

(22) Filed: Jun. 1, 2007

Related U.S. Application Data
(63) Continuation of application No. PCT/JP04/18285, filed on Dec. 8, 2004.

(51) Int. Cl. G06K 17/00; G06K 19/00; H04B 1/59; H04B 5/02

(52) U.S. Cl. 340/10.1

(57) ABSTRACT

A tag information selecting method variably sets a maximum distance for which a tag reader/writer is to make contactless communication with an electronic tag, and determines as a processing target each electronic tag that is separated by a distance shorter than or equal to the maximum distance from the tag reader/writer, of electronic tags located within a communicatable range of the tag reader/writer, and validates information read from and/or information to be written to each electronic tag that is determined as the processing target.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2004/018285 filed Dec. 8, 2004, in the Japanese Patent Office, the disclosure of which is hereby incorporated by reference.

### BACKGROUND OF THE INVENTION

1. Field of the Invention

The present invention generally relates to tag information selecting methods, electronic apparatuses and computer-readable storage media, and more particularly to a tag information selecting method for selecting information read from an electronic tag and/or information to be written to the electronic tag, an electronic apparatus that employs such a tag information selecting method, and a computer-readable storage medium that stores a program for causing a computer to realize a tag information selecting function.

2. Description of the Related Art

Recently, Radio Frequency Identification (RFID) is utilized in various fields as an identification technique for making contactless recognition of data carriers using radio waves, and various kinds of electronic tags have been proposed. The electronic tags are also referred to as RFID tags, IC tags and the like. Generally, the electronic tag is made up of an IC chip having a memory function, and a compact antenna embedded therein. The electronic tag communicates, by radio waves, with an external tag reader and/or writer (hereinafter simply referred to as a tag reader/writer). Hence, it is possible to read and identify an identification number (ID number) that is assigned to each individual electronic tag, and read data from or write data to the electronic tag. The electronic tag is adhered on or embedded into a target object, and for this reason, various shapes have been proposed for the electronic tag depending on its usage.

The electronic tags may be categorized into an active tag having a built-in battery, and a passive tag having no built-in battery, depending on the method of generating the radio waves. The active tag generates the radio waves by itself, so as to send information thereof to the tag reader/writer. On the other hand, the passive tag sends the information thereof to the tag reader/writer using the energy of the radio waves generated from the tag reader/writer. In addition, the electronic tag may also be categorized into a system utilizing electromagnetic induction and a system utilizing microwaves, depending on the frequency band that is used. Standards are being decided for the specifications of the various kinds of electronic tags by the International Organization for Standardization (ISO).

For example, in a case where the electronic tag is provided on each of a large number of target objects that are transported on a belt conveyer, the tag reader/writer communicates with each electronic tag that enters within a communicatable range, of the electronic tags that are provided on the target objects that are transported on the belt conveyer. Accordingly, in such a case, the target objects provided with the electronic tags that are processing targets of the tag reader/writer simply need to be placed on the belt conveyer.

However, in a case where the electronic tags are provided on the target objects that are randomly placed on the floor, for example, and only desired electronic tags are to become the processing targets of the tag reader/writer, the user must manually select the target objects provided with the desired electronic tags, one by one, because the tag reader/writer will communicate with all of the electronic tags within the communicatable range of the tag reader/writer. Moreover, in a case where the tag reader/writer is constructed to temporarily store therein the information from all of the electronic tags within the communicatable range, the user must perform operations such as manually validating only the information from the desired electronic tags that are the processing targets and manually deleting the information from the electronic tags other than the processing targets, thereby placing a considerable large load on the user.

Particularly in a case where the tag reader/writer subjects the information that is received from the electronic tag to a predetermined process and automatically displays the processed result, the user must perform operations such as manually storing only the processed result for the desired electronic tag that is the processing target. In addition, since the tag reader/writer subjects the information received from all of the electronic tags within the communicatable range to the predetermined process, an extremely large amount of information must be processed in the tag reader/writer. Hence, in this case, the load on the user is large, and further, the load on the tag reader/writer is large.

The load on the user is also large when the information is to be written with respect to predetermined electronic tags, of the electronic tags within the communicatable range of the tag reader/writer.

The problems described above become conspicuous especially when the tag reader/writer is a portable device and communicates with the electronic tags that are arranged at random.

The communicatable range of the tag reader/writer is determined depending on the method of generating the radio waves, the frequency bands used, the performance of the antenna and the like. Normally, the communicatable range of the tag reader/writer is fixed, and cannot be arbitrarily varied. For this reason, if the communicatable range of the tag reader/writer is extremely narrow, it is possible to select the desired electronic tag by moving the tag reader/writer close to the desired electronic tag, but the load on the user increases in that the user must be aware of the accurate distance between the tag reader/writer and the desired electronic tag, thereby making the tag reader/writer difficult or uneasy to use. On the other hand, if the communicatable range of the tag reader/writer is widened, the user no longer needs to be aware of the accurate distance between the tag reader/writer and the desired electronic tag, but the tag reader/writer may communicate with the other electronic tags that are located in the vicinity of the desired electronic tag, thereby making it necessary for the user to perform an operation of manually making only the desired electronic tag the processing target. Therefore, the method of selecting the desired electronic tag as the processing target by utilizing the peculiar communicatable range of the tag reader/writer is not practical because the communicatable range is fixed to each tag reader/writer.

For example, Japanese Laid-Open Patent Application No. 2003-8481 and Japanese Published Patent Application No. 2003-532203 propose tag readers that adjust a transmission power level with respect to the electronic tag depending on a reception power level that is notified from the electronic tag.

### SUMMARY OF THE INVENTION

Accordingly, it is a general object of the present invention to provide a novel and useful tag information selecting method, electronic apparatus and computer-readable storage medium, in which the problems described above are suppressed.

Another and more specific object of the present invention is to provide a tag information selecting method, an electronic apparatus and a computer-readable storage medium, which can reduce the load on the user who operates the electronic apparatus that is provided with a tag reader/writer function.

Still another object of the present invention is to provide a tag information selecting method comprising a setting step variably setting a maximum distance for which a tag reader/writer is to make contactless communication with an electronic tag; and a validating step determining as a processing target each electronic tag that is separated by a distance shorter than or equal to the maximum distance from the tag reader/writer, of electronic tags located within a communicatable range of the tag reader/writer, and validating information read from and/or information to be written to each electronic tag that is determined as the processing target. According to the tag information selecting method of the present invention, it is possible to reduce the load on the user who operates the electronic apparatus that is provided with the tag reader/writer function.

A further object of the present invention is to provide an electronic apparatus for reading information from and/or writing information to an electronic tag by a contactless communication, comprising a setting part configured to variably set a maximum distance for which a tag reader/writer is to make contactless communication with an electronic tag; and a validating part configured to determine as a processing target each electronic tag that is separated by a distance shorter than or equal to the maximum distance from the tag reader/writer, of electronic tags located within a communicatable range of the tag reader/writer, and to validate information read from and/or information to be written to each electronic tag that is determined as the processing target. According to the electronic apparatus of the present invention, it is possible to reduce the load on the user who operates the electronic apparatus that is provided with the tag reader/writer function.

Another object of the present invention is to provide a computer-readable storage medium that stores a program for causing a computer to read information from and/or write information to an electronic tag by a contactless communication, the program comprising a setting procedure causing the computer to variably set a maximum distance for which a tag reader/writer is to make contactless communication with an electronic tag; and a validating procedure causing the computer to determine as a processing target each electronic tag that is separated by a distance shorter than or equal to the maximum distance from the tag reader/writer, of electronic tags located within a communicatable range of the tag reader/writer, and to validate information read from and/or information to be written to each electronic tag that is determined as the processing target. According to the computer-readable storage medium of the present invention, it is possible to reduce the load on the user who operates the electronic apparatus that is provided with the tag reader/writer function.

Other objects and further features of the present invention will be apparent from the following detailed description when read in conjunction with the accompanying drawings.

### BRIEF DESCRIPTION OF THE DRAWINGS

FIG. 1 is a system block diagram showing an important part of an embodiment of an electronic apparatus according to the present invention;

FIG. 2 is a diagram showing a data format used by an electronic tag;

FIG. 3 is a diagram showing contents that are displayed on a display part when setting a limit value of a main item;

FIG. 4 is a diagram showing contents that are displayed on the display part when setting limit values of detailed information;

FIG. 5 is a diagram showing tag information and image that are displayed on the display part;

FIG. 6 is a flow chart for generally explaining a read operation of the electronic apparatus;

FIG. 7 is a flow chart for explaining the read operation of the electronic apparatus in more detail; and

FIG. 8 is a flow chart for generally explaining a write operation of the electronic apparatus.

### DESCRIPTION OF THE PREFERRED EMBODIMENTS

In the present invention, a maximum distance for which a tag reader/writer is to make a contactless (or wireless) communication with an electronic tag is variably set. Of the electronic tags that are located within a communicatable range of the tag reader/writer, those electronic tags that are separated from the tag reader/writer by distances shorter than or equal to the maximum distance are determined to be processing targets. Information read from and/or information to be written to the electronic tags that are the processing targets are validated. In other words, the information read from and/or information to be written to the electronic tags that are located within the communicatable range but are not the processing targets are invalidated. For this reason, the electronic tags that are the processing targets are automatically determined without requiring the user to be aware of or, to manually select the processing targets. As a result, it is possible to reduce the load on the user when selecting the electronic tags that are to become the processing targets.

In a case where the tag reader/writer is to receive information from the electronic tag and automatically display the information or a processed result after subjecting the information to a predetermined process, the present invention can receive the information from not all of the electronic tags located within the communicatable range, but only the information from the electronic tags that are automatically determined as the processing targets. Hence, the tag reader/writer can automatically display only the information from the electronic tags that are the processing targets or, the processed result after subjecting only the information from the electronic tags that are the processing targets. Consequently, it is possible to also reduce the load on the tag reader/writer in this case.

Next, a description will be given of embodiments of the tag information selecting method, the electronic apparatus and the computer-readable storage medium according to the present invention, by referring to the drawings.

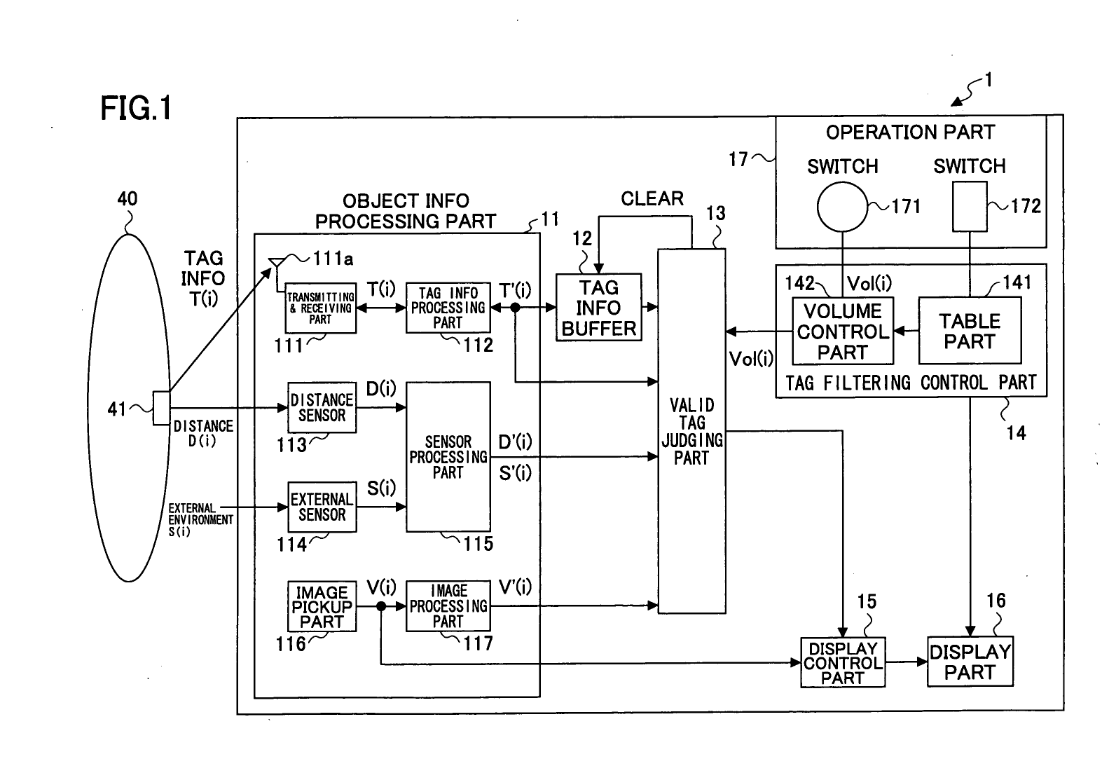

FIG. 1 is a system block diagram showing an important part of this embodiment of the electronic apparatus according to the present invention. This embodiment of the electronic apparatus employs an embodiment of the tag information selecting method according to the present invention and an embodiment of the computer-readable storage medium according to the present invention. In this embodiment, it is assumed for the sake of convenience that the present invention is applied to a portable electronic apparatus, but the present invention can of course be applied to an electronic apparatus that is to be set up. The electronic apparatus to which the present invention is applicable is not limited to the tag reader/writer, and the present invention is applicable to any electronic apparatus having a tag reader/writer function, such as a Personal Computer (PC) and a Personal Digital Assistance (PDA). Furthermore, it is assumed in this embodiment for the sake of convenience that the electronic tag is an active tag, but the electronic tag may of course be a passive tag.

In FIG. 1, the electronic apparatus 1 having the tag reader/writer function includes an object information processing part 11, a tag information buffer 12, a valid tag judging part 13, a tag filtering control part 14, a display control part 15, a display part 16 and an operation part 17. The electronic apparatus 1 can read information from an electronic tag 41 that is provided on a target object 40 and write information to this electronic tag 41, by the tag reader/writer function. The target object 40 is not limited to an item such as a product, and may be a wall, ceiling, floor and the like of a building. In addition, the target object 40 may be a person. The contactless communication between the electronic apparatus 1 and the electronic tag 41 by the tag reader/writer function of the electronic apparatus 1 can be made by a known method, and a detailed description thereof will be omitted in this specification. The electronic tag 41 is also referred to as an RFID tag, an IC tag and the like, and has a known construction made up of an IC chip having a memory function, and a compact antenna embedded therein.

The object information processing part 11 includes a transmitting and receiving part 111, a tag information processing part 112, a distance sensor part 113, an external sensor part 114, a sensor processing part 115, an image pickup (or camera) part 116 and an image (or video) processing part 117. The tag filtering control part 14 includes a table part 141 and a volume control part 142. The operation part 17 includes a plurality of keys and/or buttons including a switch 172 and volume switch 171. Of course, the display part 16 and the operation part 17 may be integrally provided in the form of a touch panel, for example.

In a case where the electronic apparatus 1 has a basic hardware structure made up of a processor such as a CPU and a storage part such as a memory, the functions of the tag information buffer 12 and the table part 141 may be realized by the storage part, and the functions of the tag information processing part 112, the sensor processing part 115, the image processing part 117, the valid tag judging part 13, the volume control part 142 and the display control part 15 may be realized by the processor.

The transmitting and receiving part 111 includes an antenna 111a, and is capable of making contactless communication, by a known method, with the electronic tag 41 that is located within a communicatable range. The communicatable range is determined depending on the method of generating the radio waves, the frequency bands used, the performance of the antenna 111a and the like, and is normally fixed. In a case where the operation mode of the electronic apparatus 1 is set to a read mode, the transmitting and receiving part 111 receives tag information T(i) from the electronic tag 41 and supplies this tag information T(i) to the tag information processing part 112. The tag information processing part 112 converts (that is, demodulates) the received tag information T(i) into tag information T′(i) having a format suited for the processing within the electronic apparatus 1, supplies the tag information T′(i) to and stores this tag information T′(i) in the tag information buffer 12, and also supplies this tag information T′(i) to the valid tag judging part 13. On the other hand, in a case where the operation mode of the electronic apparatus 1 is set to a write mode, the information that is stored in the tag information buffer 12 and is to be written to the electronic tag 41 is converted (that is, modulated) into information having a format suited for the transmission and reception by the tag information processing part 112, and the converted (that is, modulated) information is transmitted from the transmitting and receiving part 111 to the electronic tag 41.

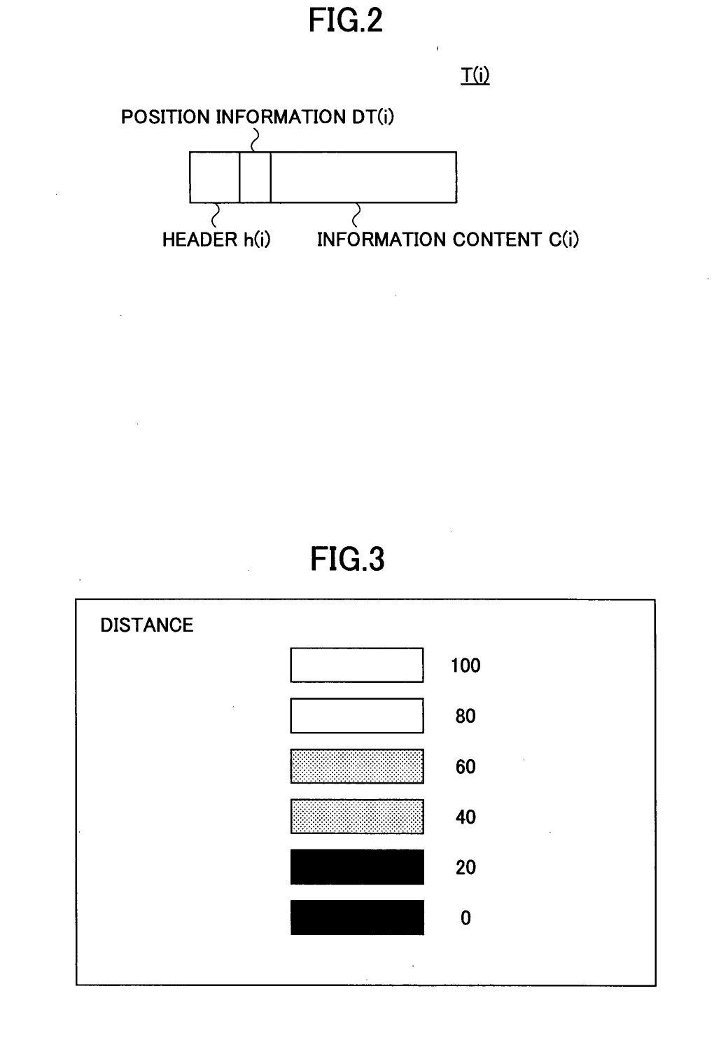

FIG. 2 is a diagram showing a data format used by the electronic tag 41. The tag information T(i) that is stored by the memory function of the electronic tag 41 is formed by a header h(i), a position information DR(i) and information content C(i) as shown in FIG. 2. The header h(i) is recorded with an identification (ID) information peculiar to the electronic tag 41, attribute information indicating the attribute of the information recorded in the electronic tag 41, information indicating the type of information recorded in the electronic tag 41, information indicating a provider of the information recorded in the electronic tag 41, and the like. The position information DT(i) indicates the position of the electronic tag 41, and is recorded if the position of the target object 40 that is provided with the electronic tag 41 is determined. The information content C(i) is recorded with various information related to the electronic tag 41 and/or the target object 40. The various information related to the target object 40 includes attribute information of the target object 40. The tag information T(i) is readable by the transmitting and receiving part 111, and the information content C(i) is writable by the transmitting and receiving part 111.

The distance sensor part 113 includes one or a plurality of sensors, and has a known structure for detecting the distance between the electronic apparatus 1 and the electronic tag 41 and outputting distance information D(i). The distance between the electronic apparatus 1 and the electronic tag 41 may be detected using an ultrasonic sensor, for example, and direction information is also included in the distance information D(i). In addition, the distance between the electronic apparatus 1 and the electronic tag 41 may also be detected by measuring a return time of a radio signal returned from the electronic tag 41, measuring an intensity of a radio signal returned from the electronic tag 41, detecting a change in a periodic interval of energy transmitted from the electronic tag 41, and the like. In these latter cases, the distance sensor part 113 may be omitted, and it is only necessary to detect by the sensor processing part 115 the time or intensity of the radio signal or the change in the periodic interval of the energy from the electronic tag 41 detected by the transmitting and receiving part 111. The methods of obtaining the distance between the electronic apparatus 1 and the electronic tag 41 without the use of the distance sensor part 113 in these latter cases are proposed in a Japanese Published Patent Application No. 2002-525640, for example.

The external sensor part 114 includes one or a plurality of sensors for detecting an external environment of the electronic apparatus 1, and has a known structure for detecting the external environment and outputting external environment information S(i). For example, the external environment of the electronic apparatus 1 to be detected by the external sensor part 114 includes the temperature, humidity, weather, brightness, sound volume, absolute position and the like. In a case where the external sensor part 114 includes a Ground Positioning System (GPS) sensor, the external sensor part 114 outputs absolute position information (or coordinate) D(t) of the electronic apparatus 1.

The external environment information S(i) output from the external sensor part 114 and the distance information D(i) output from the distance sensor part 113 are supplied to the sensor processing part 115. The sensor processing part 115 converts the distance information D(i) and the external environment information S(i) into distance information D′(i) and external environment information S′(i) respectively having a format suited for the processing within the electronic apparatus 1, and supplies the distance information D′(i) and the external environment information S′(i) to the valid tag judging part 13.

The image pickup part 116 has a known structure including CCDs or the like, and picks up the image of the target object 40 when the user moves and directs the electronic apparatus 1 to capture the image of the target object 40. The image pickup part 116 outputs video information V(i) of the image of the target object 40 that is picked up, and supplies the video information V(i) to the image processing part 117 and the display control part 15 which will be described later. For example, in a case where the electronic apparatus 1 is a portable telephone set having a built-in camera, it is possible to use the camera function of the portable telephone set as the image pickup part 116. The image processing part 117 subjects the video information V(i) to known image recognition process and contour extraction process, converts the video information V(i) into video information V′(i) having a format suited for the processing within the electronic apparatus, and supplies the video information V′(i) to the valid tag judging part 13.

The table part 141 stores main items including the maximum distance between the electronic apparatus 1 and the electronic tag with which the electronic apparatus 1 is to make the contactless communication, the information related to the electronic tag, the information related to the external environment of the electronic apparatus 1, the user information and the like. Detailed information having a hierarchical structure may be stored with respect to each of the main items. The information related to the electronic tag includes information related to the electronic tag itself, and information related to the target object on which the electronic tag is provided. The information related to the electronic tag itself includes attribute information such as the provider (company or shop) of the electronic tag, the date and time of generation of the electronic tag, and the effective term (or expiry date) of the electronic tag. The information related to the target object on which the electronic tag is provided includes attribute information such as the manufacturer (company or shop) of the target object, the type or name of the target object, the price of the target object, the color or design of the target object, the description related to the target object, and a guidance (map or the like) within the target object (building). The information related to the external environment of the electronic apparatus 1 includes the temperature, humidity, weather, brightness, sound volume, absolute position, and time information such as the date and time, and the like. The user information includes the company or shop the user is interested in, the type of product, the price of the product, the external environment, news, and the like.

The detailed information with respect to the information related to the electronic tag, the information related to the external environment of the electronic apparatus 1, and the user information includes the language in which the information is provided, for example. The detailed information with respect to the user information, such as the type of the product, for example, is as follows. That is, if the type of the product is shoes, the detailed information with respect to the shoes includes information indicating whether or not the shoes have shoe strings, and whether the shoes are slip-on, boots or sandals.

The main items and the detailed information stored in the table part 141 may be default information or, input from the operation part 17 by the user and stored in the table part 141. In addition, it is desirable that the main items and the detailed information stored in the table part 141 are arbitrarily modifiable (including addition and deletion) from the operation part 17 by the user. The user may operate the switch 172 to select each main item and each detailed information displayed on the display part 16. With respect to each main item that is selected, the user may operate the volume switch 171 to set the limit value of the main item by the volume control part 142. More particularly, if the main item is the maximum distance between the electronic apparatus 1 and the electronic tag to which the electronic apparatus 1 is to make the contactless communication, for example, it is possible to set an upper limit value of this maximum distance. For example, if the main item is the cost of the product, it is possible to set an upper limit value of the cost of the product. In addition, if the main item is the company name, it is possible to set an upper limit value of the interest (or degree of interest) with respect to this company name. With respect to each detailed information of the selected main item, the user may similarly operate the volume switch 171 and set the limit value of the detailed information by the volume control part 142. Accordingly, the limit value may be set individually with respect to the plurality of detailed information with respect to each main item, and it is possible to substantially assign a different priority order for each detailed information even for the same main item. A limit value Vol(i) that is set by the volume control part 142 is supplied to the valid tag judging part 13.

The switch 172 and the volume switch 171 may be a mechanical switch such as a rotary knob and a slide button or, may be buttons or the like displayed on the display part 16 or the touch panel. In addition, the switch 172 and the volume switch 171 may be provided integrally.

FIG. 3 is a diagram showing contents that are displayed on the display part 16 when setting the limit value of the main item. More particularly, FIG. 3 shows the contents that are displayed on the display part 16 when the maximum distance between the electronic apparatus 1 and the electronic tag to which the electronic apparatus 1 is to make the contactless communication is selected as the main item by the user by operating the switch 172. In FIG. 3, 0 through 100 indicate the limit values (distances) in arbitrary units. It is assumed for the sake of convenience that the maximum distance is set to 60 arbitrary units by operating the volume switch 171. The maximum distance is set to a value within the communicatable range (communicatable distance) in which the electronic apparatus 1 is able to communicate with the electronic tag.

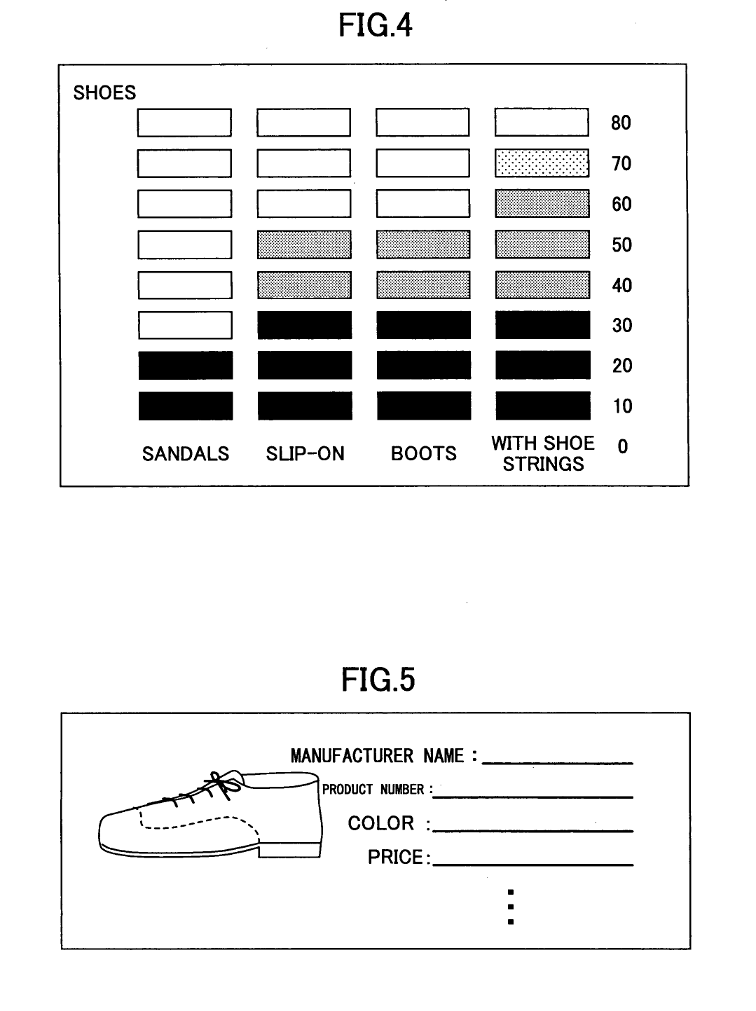

FIG. 4 is a diagram showing contents that are displayed on the display part 16 when setting the limit values of the detailed information. More particularly, FIG. 4 shows the contents that are displayed on the display part 16 when the main item is the type of the product, namely, shoes, and the shoes with shoe strings, slip-on, boots and sandals are selected as the detailed information. It is assumed for the sake of convenience that the limit values with respect to the shoes are already set, similarly to the case shown in FIG. 3. In FIG. 4, 0 through 100 indicate the limit values (degree of interest) of the detailed information in arbitrary units. It is assumed for the sake of convenience that the degree of interest for the sandals is set to 20 arbitrary units, the degree of interest for the slip-on is set to 50 arbitrary units, the degree of interest for the boots is set to 50 arbitrary units, and the degree of interest for the shoes with shoe strings is set to 70 arbitrary units by operating the volume switch 171.

Of course, the display formats for the main items and the detailed information are not limited to the display format shown in FIGS. 3 and 4, and any display formats may be used as long as it is possible to set the limit values with respect to the main items and the detailed information. In addition, instead of setting the limit values with respect to the main items and the detailed information, it is of course possible to set the limit ranges with respect to the main items and the detailed information.

The valid tag judging part 13 judges whether or not to validate the tag information T′(i) that is successively stored in the tag information buffer 12, based on a comparison of at least one of the information selected from the tag information T′(i), the distance information D′(i) and the external environment information S′(i) and the corresponding limit values (or limit ranges) obtained from the volume control part 142. In this embodiment, the valid tag judging part 13 judges whether or not to validate the tag information T′(i) within the tag information buffer 12 based on the comparison of at least the distance information D′(i) and the corresponding limit value Vol(i), that is, the maximum distance (for example, 60 arbitrary units). Of the tag information T′(i) stored within the tag information buffer 12, the valid tag judging part 13 validates only the tag information T′(i) that is judged as being valid. More particularly, of the tag information T′(i) within the tag information buffer 12, the tag information T′(i) that is not judged as being valid by the valid tag judging part 13 is successively invalidated, that is, erased or put into an overwritable state, in response to a clear signal from the valid tag judging part 13. For this reason, the storage capacity of the tag information buffer 12 can be suppressed to a relatively small value, and the information that is of not much interest to the user is basically not processed within the electronic apparatus 1, thereby reducing the load on the processor of the electronic apparatus 1.

The tag information T′(i) within the tag information buffer 12, that is judged as being valid by the valid tag judging part 13, is successively supplied to the display control part 15 from the valid tag judging part 13, and is displayed on the display part 16 together with the corresponding video information V′(i). When not displaying the tag information T′(i) and displaying only the target object 40 that is picked up by the image pickup part 116, the video information V(i) is displayed on the display part 16 via the display control part 15. Because the image pickup part 116 is provided with a known automatic focus adjustment function that automatically adjusts the focal distance to the target object 40 that is to be picked up, the image processing part 117 can obtain the distance information between the electronic apparatus 1 and the target object 40 from the focal distance that is obtained by the automatic focus adjustment function. The video information V(i) is obtained when the user moves and directs the electronic apparatus 1 to capture the image of the target object 40 and the image of the target object 40 is picked by the image pickup part 116. For this reason, the direction information of the target object 40 with respect to the electronic apparatus 1 is known in advance. On the other hand, the distance information between the electronic apparatus 1 and the electronic tag 41 is obtained in the sensor processing part 115 based on the distance information D(i) from the distance sensor part 113 and/or the absolute position information D(t) from the external sensor part (GPS sensor) 114, and this distance information also includes the direction information of the electronic tag 41 with respect to the electronic apparatus 1. Accordingly, in the display control part 15, it is possible to discriminate the corresponding target object 40 and electronic tag 41, and to obtain the corresponding tag information T′(i) and video information V′(i), based on the two distance information (including the direction information) obtained from the image processing part 117 and the sensor processing 115 via the valid tag judging part 13.

FIG. 5 is a diagram showing the tag information and the image that are displayed on the display part 16. FIG. 5 shows a case where the tag information T′(i) read from the electronic tag 41 that is located within the communicatable range and is located at a position separated from the electronic apparatus 1 by a distance shorter than or equal to the set maximum distance, includes the manufacturer name, the product (or model) number, the color, the price and the like of the product namely, shoes, and this tag information T′(i) is displayed in correspondence with the video information V′(i) of the target object (shoes) 40 on which the electronic tag 41 is provided. Of course, the display format of the tag information T′(i) and the video information V′(i) is not limited to that shown in FIG. 5, and it is possible to employ various other display formats that use a tabulation format, a scroll format and the like.

Therefore, only the information of the electronic tag that is of interest to the user is automatically displayed on the display part 16, without requiring the user to be aware of the electronic tag. Hence, compared to the case where the user himself must manually select the electronic tag (or the target object), it is possible to reduce the load on the user.

In this embodiment, the tag information T′(i) stored in the tag information buffer 12 does not remain within the tag information buffer 12 when read from the tag information buffer 12 and displayed on the display part 16. However, it is of course possible to store the tag information T′(i) read from the tag information buffer 12 into an internal memory (not shown) or an external memory (not shown) of the electronic apparatus 1, for example. In the latter case, the external memory may be connected externally to the electronic apparatus 1 or, may be formed by a storage part that forms a user database or the like and is accessible via a network. The timing at which the displayed tag information T′(i) is erased from the tag information buffer 12 is not limited to a particular timing. For example, the displayed tag information T′(i) may be erased from the tag information buffer 12 when the distance between the electronic apparatus 1 and the electronic tag 41 becomes shorter than or equal to a predetermined value or, when a predetermined time elapses from the time when the tag information T′(i) is displayed or, when the power of the electronic apparatus 1 is turned OFF.

In a case where the user does not direct the electronic apparatus 1 towards the target object 40 to capture the target object, no video information V′(i) is supplied to the display control part 15. Thus, in this case, only the tag information T′(i) is displayed on the display part 16.

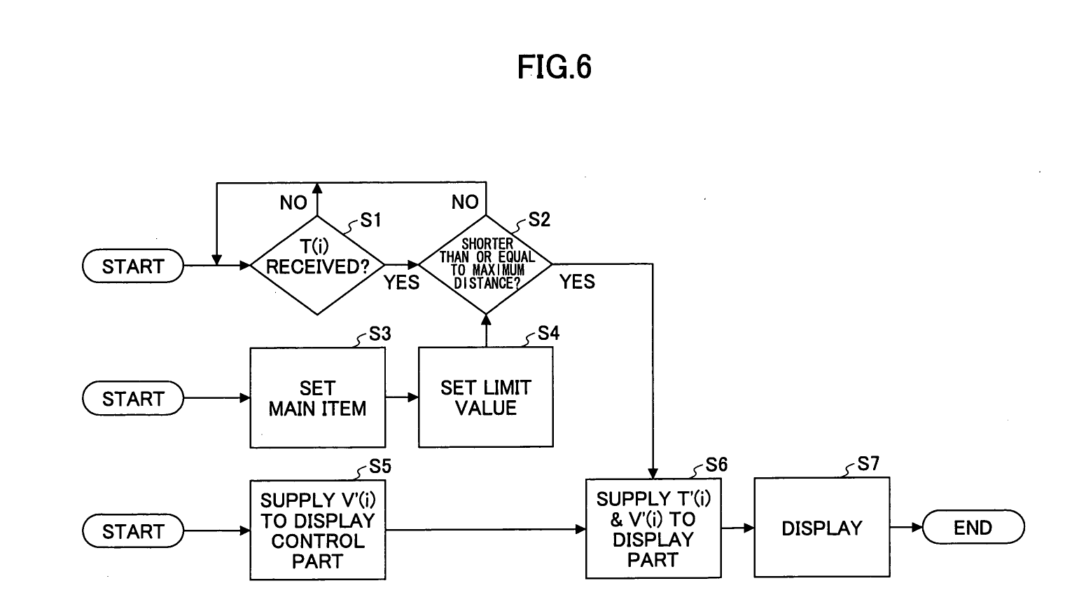

FIG. 6 is a flow chart for generally explaining a read operation of the electronic apparatus 1. In FIG. 6, in a step S1, the tag processing part 112 decides whether or not the tag information T(i) from the electronic tag 41 is received by the transmitting and receiving part 111, and the process advances to a step S2 if the decision result in the step S1 is YES. On the other hand, in a step S3, the user operates the switch 172 and sets, as the main item, the maximum distance between the electronic apparatus 1 and the electronic tag 41 to which the electronic apparatus 1 is to make the contactless communication. In a step S4, the user operates the volume switch 171 to set the limit value of the maximum distance. In a step S5, the video information V(i) of the target object 40 picked up by the image pickup part 116 is supplied to the image processing part 117, and the video information V′(i) that is obtained via the image processing part 117 is supplied to the display control part 15.

In the step S2, the valid tag judging part 13 decides whether or not the distance information D′(i) that is obtained via the distance sensor part 113 and the sensor processing part 115 and stored in the tag information buffer 12 is shorter than or equal to the maximum distance that is set in the step S4. The process returns to the step S1 id the decision result in the step S2 is NO. If the decision result in the step S2 is YES, it is judged that the tag information T′(i) within the tag information buffer 12 is valid, and in a step S6, the display control part 15 supplies the valid tag information T′(i) within the buffer 12 and the corresponding video information V′(i) to the display part 16. Accordingly, in a step S7, the display part 16 displays the valid tag information T′(i) and the corresponding video information V′(i).

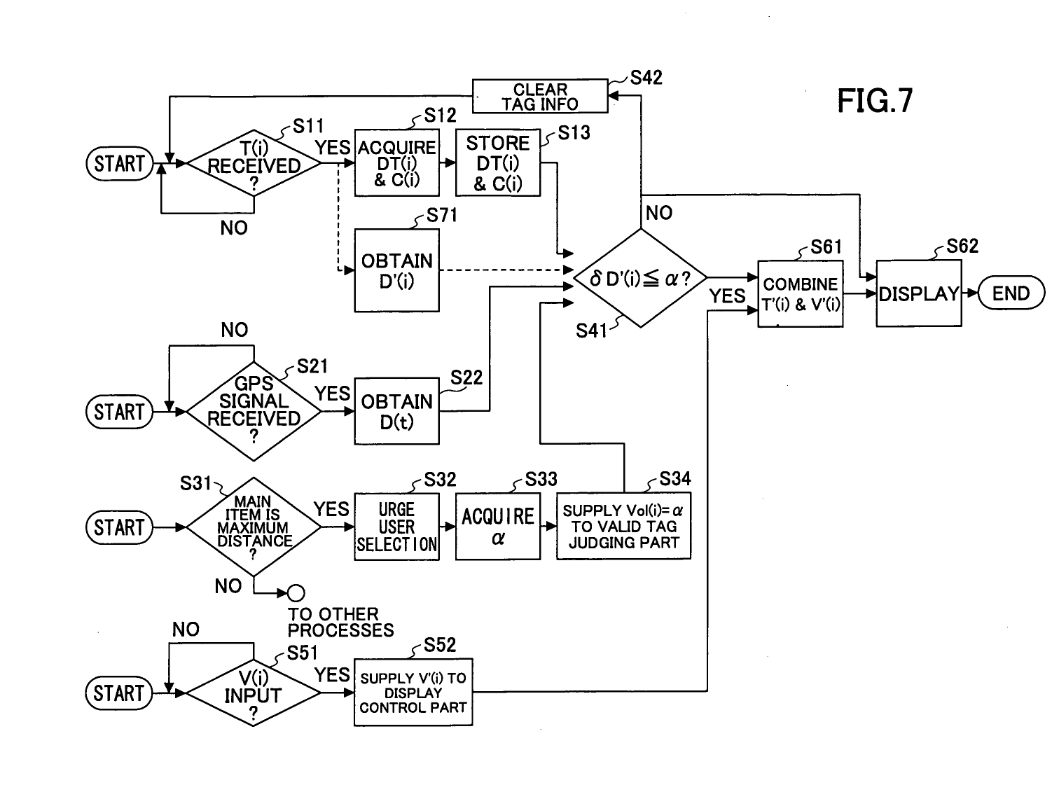

FIG. 7 is a flow chart for explaining the read operation of the electronic apparatus 1 in more detail. In FIG. 7, in a step S11, the tag information processing part 112 decides whether or not the tag information T(i) from the electronic tag 41 is received by the transmitting and receiving part 111. The process advances to a step S12 if the decision result in the step S11 is YES. In the step S12, the tag information processing part 112 acquires the position information DT(i) and the information content C(i) within the tag information T(i), based on the tag information T(i) obtained from the transmitting and receiving part 111. In a step S13, the tag information buffer 12 stores the position information DT(i) and the information content C(i), and the process advances to a step S41 which will be described later.

On the other hand, in a step S21, the sensor processing part 115 decides whether or not the position information is input from the GPS sensor or the like of the external sensor part 114. The process advances to a step S22 if the decision result in the step S21 is YES. In the step S22, the sensor processing part 115 obtains the absolute position information D(t) of the electronic apparatus 1 based on the position information, supplies the absolute position information D(t) to the valid tag judging part 13, and the process advances to the step S41 which will be described later.

A step S31 decides whether or not the maximum distance between the electronic apparatus 1 and the electronic tag 41 to which the electronic apparatus 1 is to make the contactless communication is set as the main item by the operation of the switch 172. If the decision result in the step S31 is YES, a step S32 displays candidates of the limit values Vol(i) of the maximum distance from the table part 141, and urges the user to make a selection. If the decision result in the step S31 is NO, the process advances to another process that is not directly related to the subject matter of the present invention. In a step S33, the volume control part 142 acquires the limit value Vol(i)=α of the set maximum distance, that is selected from the candidates by the operation of the volume switch 171. A step S34 supplies the acquires limit value Vol(i) to the valid tag judging part 13, and the process advances to the step S41 which will be described later.

In a step S51, the image processing part 117 decides whether or not the video information V(i) of the target object 40 that is picked up by the image pickup part 116 is input. If the decision result in the step S51 is YES, a step S52 supplies the video information V′(i) that is obtained via the image processing part 117 is supplied to the display control part 15, and the process advances to a step S61 which will be described later.

In a case where the position information DT(i) or the absolute position information D(t) cannot be acquired, it is possible to carry out a step S71 as indicated by a dotted line in FIG. 7. In the step S71, the sensor processing part 115 supplies to the valid tag judging part 13 the distance information D′(i) indicating the distance from the electronic apparatus 1 to the electronic tag 41, based on the distance information D(i) that is input from the ultrasonic sensor or the like of the distance sensor part 113, and the process advances to the step S41.

In the step S41, the valid tag judging part 13 decides whether or not relative distance information δD′(i) between the electronic apparatus 1 and the electronic tag 41, that is described by δD′(i)²={DT(i)−D(t)}² satisfies a relationship δD′(i)≦α, based on the position information DT(i) and the absolute position information D(t). If the position information DT(i) or the absolute position information D(t) cannot be acquired, the valid tag judging part 13 in this case decides in the step S41 whether or not the relative distance information δD′(i) between the electronic apparatus 1 and the electronic tag 41, that is described by δD′(i)²=D′(i)² satisfies a relationship δD′(i)≦α, based on the distance information D′(i).

If the decision result in the step S41 is NO, it is judged that the tag information T′(i) within the tag information buffer 12 is invalid, and in a step S42, the valid flag judging part 13 deletes the tag information T′(i) within the tag information buffer 12, and the process returns to the step S11. In addition, if the decision result in the step S41 is NO and the target object 40 that is picked up by the image pickup part 116 is to be simply displayed without displaying the tag information T′(i), the video information V(i) is supplied to the display control part 15, and thus, the video information V(i) is displayed on the display part 16 in a step S62 which will be described later. On the other hand, if the decision result in the step S41 is YES, it is judged that the tag information T′(i) within the tag information buffer 12 is valid. Hence, in the step S61, the display control part 15 carries out a combining (or synthesizing) process to overlap the valid tag information T′(i) within the tag information buffer 12 and the corresponding video information V′(i), and supplies the combined tag information T′(i) and video information V′(i) to the display part 16. Consequently, in a step S62, the display part 16 displays the valid tag information T′(i) and the corresponding video information V′(i).

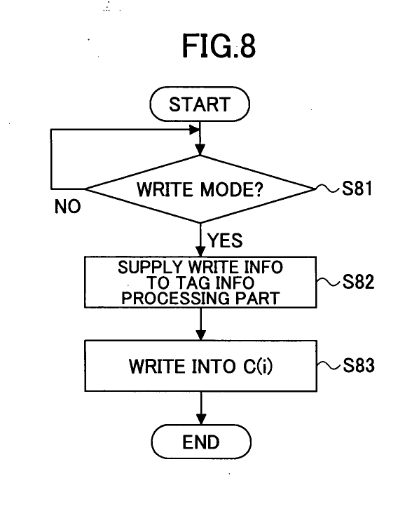

Information may be written to the electronic tag 41, the tag information T′(i) of which is displayed on the display part 16. FIG. 8 is a flow chart for generally explaining a write operation of the electronic apparatus 1. In a state where at least the tag information T′(i) is displayed on the display part 16 in the step S62 shown in FIG. 7, the user can set the operation mode of the electronic apparatus 1 to the write mode by operating the operation part 17. In FIG. 8, in a step S81, the processor of the electronic apparatus 1 decides whether or not the operation mode is set to the write mode. The process advances to a step S82 if the decision result the step S81 is YES. In the step S82, the user inputs the write information to the processor of the electronic apparatus 1 by operating the operation part 17, and the input write information is supplied to the tag information processing part 112. In a step S83, the transmitting and receiving part 111 writes the write information that is obtained from the tag information processing part 112 into the information content C(i) within the electronic tag 41 by a known method, and the process ends.

Since the electronic apparatus 1 can be set to the write mode in the state where the information from the electronic tag and of interest to the user is displayed on the display part 16, it is possible to simplify the operation of selecting only the electronic tags of interest to the user in a case where the user positively wishes to write information to the electronic tag, to thereby reduce the load on the user.

The write information is not limited to particular information. For example, the write information may include access information indicating that the user has accessed the tag information T(i) within the electronic tag 41, and information such as the name of the user. In the first case, it is possible to store information related to the number of accesses made from the user, into the information content C(i) within the electronic tag 41. On the other hand, in the latter case, if the target object 40 on which the electronic tag 41 is provided is a product, it is possible to store information related to the user's reservation of the product, into the information content C(i) within the electronic tag 41. Furthermore, it is also possible to automatically write information such as the date and time into the information content C(i), together with the information input by the user, and it is possible to enable the user to set the information that is to be automatically written into the information content C(i) together with the information input by the user.

Of course, even if the user does not set the operation mode of the electronic apparatus 1 to the write mode, the information related to the number of accesses made from the user, for example, may be automatically written to the electronic tag.

The computer-readable storage medium according to the present invention stores a program for causing the computer to carry out the tag information selecting method described heretofore. The recording medium which forms the computer-readable storage medium is not limited to a particular type, and semiconductor memory devices, magnetic recording media, optical recording media, magneto-optic recording media and the like may be used as the recording medium.

Therefore, the present invention is applicable to various kinds of electronic apparatus having the tag reader/writer function for communicating with the electronic tag.

Further, the present invention is not limited to these embodiments, but various variations and modifications may be made without departing from the scope of the present invention.

What is claimed is:

1. A tag information selecting method comprising:
a setting step variably setting a maximum distance for which a tag reader/writer is to make contactless communication with an electronic tag; and
a validating step determining as a processing target each electronic tag that is separated by a distance shorter than or equal to the maximum distance from the tag reader/writer, of electronic tags located within a communicatable range of the tag reader/writer, and validating information read from and/or information to be written to each electronic tag that is determined as the processing target.

2. The tag information selecting method as claimed in claim 1, further comprising:
a measuring step measuring a distance from the tag reader/writer to each electronic tag within the communicatable range of the tag reader/writer.

3. The tag information selecting method as claimed in claim 1, wherein said validating step determines the electronic tag that is the processing target based on a comparison of information related to the electronic tag and/or information related to an external environment of the tag reader/writer and/or user information and corresponding limit values, in addition to the maximum distance.

4. The tag information selecting method as claimed in claim 3, further comprising:
a step obtaining the information related to the electronic tag and/or the user information from information read from the electronic tag.

5. The tag information selecting method as claimed in claim 3, further comprising:
a step obtaining the information related to the external environment of the tag reader/writer based on a sensor output.

6. The tag information selecting method as claimed in claim 3, further comprising:
a step setting the limit values or limit ranges of the information related to the electronic tag and/or the information related to the external environment of the tag reader/writer and/or the user information.

7. The tag information selecting method as claimed in claim 2, further comprising:
an image pickup step picking up an image of a target object that is provided with the electronic tag; and
an output step outputting the image of the target object that is provided with the electronic tag that is the processing target, together with information read from said electronic tag that is the processing target, based on a measured result of the measuring step.

8. The tag information selecting method as claimed in claim 7, wherein said output step displays the image of the target object that is provided with the electronic tag that is the processing target, in correspondence with the information read from said electronic tag that is the processing target.

9. An electronic apparatus for reading information from and/or writing information to an electronic tag by a contactless communication, comprising:
a setting part configured to variably set a maximum distance for which a tag reader/writer is to make contactless communication with an electronic tag; and
a validating part configured to determine as a processing target each electronic tag that is separated by a distance shorter than or equal to the maximum distance from the tag reader/writer, of electronic tags located within a communicatable range of the tag reader/writer, and to validate information read from and/or information to be written to each electronic tag that is determined as the processing target.

10. The electronic apparatus as claimed in claim 9, further comprising:
a measuring part configured to measure a distance from the tag reader/writer to each electronic tag within the communicatable range of the tag reader/writer.

11. The electronic apparatus as claimed in claim 9, wherein said validating part determines the electronic tag that is the processing target based on a comparison of information related to the electronic tag and/or information related to an external environment of the tag reader/writer and/or user information and corresponding limit values, in addition to the maximum distance.

12. The electronic apparatus as claimed in claim 11, further comprising:
a part configured to obtain the information related to the electronic tag and/or the user information from information read from the electronic tag.

13. The electronic apparatus as claimed in claim 11, further comprising:
a sensor part configured to detect the information related to the external environment of the tag reader/writer and to supply the information related to the external environment to the validating part.

14. The electronic apparatus as claimed in claim 11, further comprising:
a part configured to set the limit values or limit ranges of the information related to the electronic tag and/or the information related to the external environment of the tag reader/writer and/or the user information.

15. The electronic apparatus as claimed in claim 10, further comprising:
an image pickup part configured to pick up an image of a target object that is provided with the electronic tag; and
an output part configured to output the image of the target object that is provided with the electronic tag that is the processing target, together with information read from said electronic tag that is the processing target, based on a measured result of the measuring part.

16. The electronic apparatus as claimed in claim 15, wherein said output part displays the image of the target object that is provided with the electronic tag that is the processing target, in correspondence with the information read from said electronic tag that is the processing target.

17. A computer-readable storage medium that stores a program for causing a computer to read information from and/or write information to an electronic tag by a contactless communication, said program comprising:
a setting procedure causing the computer to variably set a maximum distance for which a tag reader/writer is to make contactless communication with an electronic tag; and
a validating procedure causing the computer to determine as a processing target each electronic tag that is separated by a distance shorter than or equal to the maximum distance from the tag reader/writer, of electronic tags located within a communicatable range of the tag reader/writer, and to validate information read from and/or information to be written to each electronic tag that is determined as the processing target.

18. The computer-readable storage medium as claimed in claim 17, said program further comprising:
a measuring procedure causing the computer to measure a distance from the tag reader/writer to each electronic tag within the communicatable range of the tag reader/writer.

19. The computer-readable storage medium as claimed in claim 17, wherein said validating procedure causes the computer to determine the electronic tag that is the processing target based on a comparison of information related to the electronic tag and/or information related to an external environment of the tag reader/writer and/or user information and corresponding limit values, in addition to the maximum distance.

20. The computer-readable storage medium as claimed in claim 19, said program further comprising:
a procedure causing the computer to obtain the information related to the electronic tag and/or the user information from information read from the electronic tag.

21. The computer-readable storage medium as claimed in claim 19, said program further comprising:
a procedure causing the computer to obtain the information related to the external environment of the tag reader/writer based on a sensor output.

22. The computer-readable storage medium as claimed in claim 19, said program further comprising:
a procedure causing the computer to set the limit values or limit ranges of the information related to the electronic tag and/or the information related to the external environment of the tag reader/writer and/or the user information.

23. The computer-readable storage medium as claimed in claim 18, said program further comprising:
an image pickup procedure causing the computer to pick up an image of a target object that is provided with the electronic tag; and
an output procedure causing the computer to output the image of the target object that is provided with the electronic tag that is the processing target, together with information read from said electronic tag that is the processing target, based on a measured result of the measuring procedure.

24. The computer-readable storage medium as claimed in claim 23, wherein said output procedure causes the computer to display the image of the target object that is provided with the electronic tag that is the processing target, in correspondence with the information read from said electronic tag that is the processing target.
